(19) United States
(12) Patent Application Publication
(10) Pub. No.: US 2005/0181275 A1
(43) Pub. Date: Aug. 18, 2005

(54) Open electrochemical cell, battery and functional device

(76) Inventor: Bor Z. Jang, Fargo, ND (US)

Correspondence Address: Bor Z Jang, 2902, 28 AVE, S.W., FARGO, ND, 58103, US

(21) Appl. No.: 10/779,998

(22) Filed: Feb. 18, 2004

(51) Int. Cl. H01M 10/00; H01M 10/26; H01M 2/16; H01M 6/04

(52) U.S. Cl. 429/188; 429/247; 429/199; 429/206; 429/127; 429/7

(57) ABSTRACT

An open, liquid-state electrochemical cell that can be used as a primary or rechargeable power source for various miniaturized or portable electronic devices. The cell is composed of flexible and thin layers of anode, cathode and electrolyte materials with the electrolyte layer being exposed to open air. The electrolyte with an open configuration avoids the accumulation of gases upon storage of the cell. The electrolyte includes (a) a deliquescent material for keeping the open cell wet at all times and (b) an ion conductive material for transporting ions across the electrolyte layer. The electrolyte does not include a water-soluble polymer. The invention also provides a multi-cell battery that contains cells exhibiting the above-described features. The cell or battery, along with an electronic component, may be attached to a flexible substrate to make a functional device.

### FIELD OF THE INVENTION

The present invention relates to an electrochemical cell, a battery containing such a cell, and a functional device that relies on the operation of such a cell or battery. More particularly, the present invention relates to a primary or rechargeable electrochemical cell or battery which converts chemical energy to electrical energy using a wet or liquid-state electrolyte, yet maintains a flexible thin-layer configuration. The configuration features an incomplete enclosure of the cell or battery so that the electrolyte is partially exposed to open air.

### BACKGROUND OF THE INVENTION

Compact, thin-layer batteries are finding increasing uses in miniaturized and portable microelectronic devices such as cellular phones, personal data assistants (PDAs), digital cameras, electronic calculators, radio frequency identification (RFID) tags, temperature sensors and many other hand-held medical devices.

An electrochemical cell typically includes a negative electrode (anode), a positive electrode (cathode), an electrolyte phase disposed inbetween the two electrodes, current collectors, and a protective casing. A battery is typically composed of a multiplicity of electrochemical cells electrically connected in series, in parallel, or both. Batteries can be broadly classified into two categories: batteries with a wet electrolyte (i.e., liquid state batteries) and batteries with a solid state electrolyte (solid state batteries).

Solid state batteries have an inherent advantage in that they normally do not dry out and do not leak. However, due to limited diffusion rates of ions through the solid electrolyte, the operation of solid state batteries is more temperature dependent and they may operate well only at elevated temperatures. Limited diffusion rates result in a low ratio of electrical energy generated to their potential chemical energy.

A liquid state thin-layer battery typically includes, between the two electrodes, a separator that is soaked with a liquid electrolyte solution to function as an electrolytic liquid layer. This type of battery has to be sealed within a protective layer to prevent liquid evaporation, and is referred to as a closed or enclosed electrochemical cell. Being a closed cell, the battery tends to swell upon storage due to evolution of gases. This has been a severe problem in thin-layer batteries having no mechanical support due to the fact that the pressure imposed by the accumulated gases leads to layer separation, thus making the battery inoperative. Earlier attempts to overcome this problem included:
(1) the use of a polymer (e.g., hydroxyethylcellulose) to increase electrolyte viscosity and to adhere the battery layers together, thus overcoming the inherent problem of such batteries imposed by lack of solid support. However, the polymers used were limited in effectiveness;
(2) the addition of mercury to prevent the formation of gases (e.g., hydrogen); but, mercury is an environmental hazard;
(3) the use of a gas-permeable, but electrolyte-impermeable polymeric material as a sheathing film to enclose the battery cell which allows venting of undesirable gases formed within the battery while preventing any electrolyte loss from the battery (U.S. Pat. No. 3,901,732 to Kis, et al.); and
(4) the design of an open cell configuration in which the electrolyte is exposed to the open air, thus preventing the accumulation of gases upon storage. The electrolyte contains a deliquescent material for keeping the open cell wet at all times, an electroactive soluble material for obtaining the required ionic conductivity, and a water-soluble polymer “for obtaining a required viscosity for adhering the electrolyte layer to the electrode layers” (Z.

Nitzan, U.S. Pat. No. 5,652,043, Jul. 29, 1997 and U.S. Pat. No. 5,897,522, Apr. 27, 1999). It may be noted that the concept of using a water-soluble polymer “for obtaining a required viscosity for adhering the electrolyte layer to the electrode layers” is incorrect or, at best, misleading. It does not require an increased viscosity to provide adhesion of electrolyte to the cathode and anode layers. Instead, chemical compatibility between an electrode and the electrolyte or surface wettability of an electrode by an electrolyte liquid component promotes a good bonding or an intimate contact between the electrolyte and the electrode. Such an intimate contact ensures that the ions produced at the anode readily migrate into and through the electrolyte to reach the cathode during discharge, and back to the anode during re-charge. The presence of a small amount of water-soluble polymer in the electrolyte layer may possibly help to retain water molecules. However, we have observed that an water-soluble polymer tends to absorb too much water in the electrolyte phase, especially when the electrochemical cell operates in a high-humidity environment or when the water-soluble polymer content is relatively high. This could result in weakened interfaces between the electrolyte and the electrodes and, oftentimes, delamination between layers or warping of the substrate; the latter phenomenon being more pronounced with a paper-based substrate on which the electrochemical cell or battery is supported.

It is therefore desirable to have an electrochemical cell or battery that features an open cell configuration to prevent accumulation of gases and evaporation of liquid. It is further advantageous to have an electrochemical cell or battery containing an electrolyte layer that is free from a water-soluble polymer to prevent delamination of layers or warping of the substrate.

### SUMMARY OF THE INVENTION

The present invention provides an open liquid state electrochemical cell which can be used as a primary or rechargeable power supply for various miniaturized or portable electronic devices. Preferably, the cell is composed of flexible, thin layers of anode, cathode and electrolyte, with the electrolyte layer being exposed to open air. The electrolyte with an open configuration avoids the accumulation of gases upon storage of the cell. The electrolyte includes (a) a deliquescent material for keeping the open cell wet at all times and (b) an ion conductive material for obtaining required ionic conductivity. The electrolyte does not include a water-soluble polymer to avoid weakened layer interfaces, delamination, or substrate warping.

Preferably, however, the electrolyte layer contains water, a deliquescent material and an ion conductive material that are supported by, carried on, or impregnated in a porous structure. The porous structure is preferably a ceramic membrane, a polymer membrane, a non-woven fabric, a woven fabric, or a filter paper. This porous structure imparts a good degree of mechanical integrity to the over-all cell structure. Further preferably, the electrolyte comprises a water-compatible or hydrophillic (but water-insoluble) polymer selected from the group consisting of a lightly cross-liked polymer, a hydrogel, an interpenetrating network, a semi-interpenetrating network, and combinations thereof. These materials may constitute a part or the entirety of the porous structure. These materials facilitate an intimate contact between the electrolyte and the cathode and/or anode. Alternatively, these materials may also be made in a fine powder form and added to the electrolyte phase as a water-retaining additive. These materials are typically processed by beginning with at least one reactive chemical species that are monomers or low-molecular weight polymers (oligomers), which are activated (catalyzed or initiated) to undergo polymerization and/or chain cross-linking under the influence of heat or radiation (ultra-violet light, electron beam, ion beam, etc.). During this polymerization or cross-linking process, some of the chains can react with or be bonded to both the cathode and the anode to ensure the mechanical integrity of the resulting electrochemical cell.

There is no limitation as to the kind of anode material that can go into the presently invented open electrochemical cell. Due to the normally high reactivity between pure lithium and water, pure lithium is not a recommended active anode material. However, lithium can be an element in an alloy or mixture. Hence, the anode preferably comprises an anode active material selected from the group consisting of magnesium, aluminum, titanium, manganese, zinc, chromium, iron, nickel, tin, and combinations thereof. The anode active material may be in the form of a fine powder, a thin fiber, a thin film, or a combination thereof. The anode or cathode may comprise a carbon powder, graphite platelet, and/or graphite fiber. The cathode preferably includes an inert material not soluble in or reactive with the electrolyte. The inert material may be selected from a group consisting of a metal oxide, sulfide, phosphide, arsenide, selenide, telluride, and combinations thereof.

The ion conductive material may be selected from the group consisting of zinc-chloride, zinc-bromide, zinc-fluoride, potassium-hydroxide, and combinations thereof. A wide range of deliquescent materials may be selected for use in the present electrochemical cell. Recommended deliquescent materials include zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, and hydrogels.

The open electrochemical cell of the present invention may further comprise an anode current collector in physical contact with the anode and a cathode current collector in physical contact with the cathode. Two terminals may be connected to the anode and the cathode, respectively.

Another embodiment of the present invention is a battery comprising a plurality of electrochemical cells with at least one of the electrochemical cells having the above-described features. These cells can be connected in series and/or in parallel to provide the desired voltage and/or current levels.

Preferably, the anode, cathode and electrolyte are in the form of thin layers so that the cell or battery is flexible. Further preferably, both the anode and the cathode are thin layers with a thickness smaller than 20 μm, most preferably thinner than 10 μm. In a particularly desirable configuration, the porous structure in the electrolyte phase is a thin layer having two opposite surfaces with a first surface in physical contact with the anode and a second surface in physical contact with the cathode. For instance, the anode and the cathode may be printed, sprayed, painted, spin-coated, or somehow bonded (e.g., through the afore-mentioned cross-linking) on the opposite surfaces of a filter paper. This filter paper may be soaked with a solution of an ion conductive material and a deliquescent material before the cathode and anode are bonded to the electrolyte layer.

Still another embodiment of the present invention is a functional device comprising a flexible thin-layer open liquid-state electrochemical cell for providing the device with electrical power for its operation, with the electrochemical cell having the aforementioned features (having an open cell configuration with the electrolyte containing a deliquescent material and an ion conductive material). The device includes a substrate material and at least one electronic component attached to the substrate. The substrate may be selected from the group consisting of a greeting card, a business card, a radio frequency identification tag, a package of a food product, and a printed matter. The electronic component may be selected from the group consisting of an audio device, a visual device, a power switch, a light-emitting diode, a timer, a voltage regulator, an amplifier, an antenna, a transceiver, a sensor, an actuator, an integrated circuit, a memory, an electronic ink, and combinations thereof.

The present invention successfully addresses the shortcomings of the prior-art electrochemical cell configurations by providing a flexible thin-layer open electrochemical cell that has the following features: (1) the cell does not accumulate gases upon storage; (2) the electrolyte is capable of maintaining an adequate level of moisture due to the presence of a deliquescent material which absorbs moisture from the open air; (3) no water-soluble polymer is present to cause weakened interfaces or even delamination between the electrolyte layer and the cathode or anode layer; (4) the chemically compatible or wettable ingredients, preferably in the form of a porous separator structure, promote good contacts between layers and provide good mechanical integrity of the resulting multi-layer configuration; (5) the chemically compatible or wettable ingredients in a fine powder form can be added to the electrolyte to serve as a moisture retainer, (6) no exterior protective casing is needed, rendering the cell or battery thin, lightweight, and flexible and making it easier for mass production of the electrochemical cells, batteries, and functional devices; and (7) the cells may be manufactured in any size, shape, color and applied patterns and, hence, they are suitable for a wide variety of applications.

### BRIEF DESCRIPTION OF THE DRAWINGS

FIG. 1 A perspective view of a basic configuration of a flexible thin-layer open electrochemical cell.

FIG. 2(a) a perspective view of another possible configuration of a flexible thin-layer open electrochemical cell which contains an anode 14 on the top surface 23 of a filter paper 20 and a cathode (not seen) at a corresponding location on the bottom surface 25 of the paper with the electrolyte ingredients engaged by the portion of the filter paper between the two electrodes; (b) a perspective view of another possible configuration of a flexible thin-layer open electrochemical cell with all constituent layers implemented on the top surface of a flexible substrate 20.

FIG. 3 A perspective view of a basic configuration of a flexible thin-layer open electrochemical cell comprising current collectors 26,28 and electrode terminals 30,32, in addition to the anode, electrolyte, and cathode layers.

FIG. 4 A graph presenting the voltage-time curves of an open electrochemical cell and a prior-art open cell (containing a water-soluble polymer) measured in a laboratory air environment.

### DESCRIPTION OF THE PREFERRED EMBODIMENTS

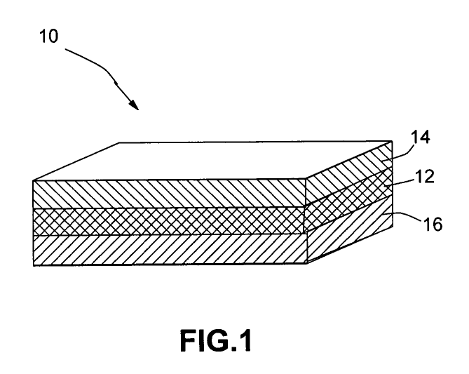

FIG. 1 illustrates a basic configuration of the flexible thin-layer open electrochemical cell 10 of the present invention. The cell includes three layers: a negative electrode (anode) 14, a positive electrode 16 and an aqueous electrolyte layer 12. The aqueous electrolyte layer 12 includes a deliquescent or hygroscopic material for keeping the open cell 10 moisturized at all times by absorbing moisture from open air. The electrolyte also includes an ion conductive material for helping to transport ions across the electrolyte layer between the two electrodes.

The aqueous electrolyte layer 12 preferably includes a porous structure that is not soluble in or reactive with the electrolyte. The deliquescent material, water, and ion conductive material are supported by, carried on, or impregnated in the porous structure. These ingredients (the deliquescent material, water, ion conductive material, and the porous structure) together constitute the electrolyte layer. The porous structure is preferably selected from the group consisting of a ceramic membrane, a polymer membrane, a non-woven fabric, a woven fabric, and a filter paper. Although not a required ingredient, this porous structure imparts a good degree of mechanical integrity to the over-all cell structure.

Further preferably, the electrolyte may include a water-compatible or hydrophillic polymer such as a lightly cross-liked polymer, a hydro-gel, an interpenetrating network (IPN), and a semi-interpenetrating network (semi-IPN). These materials may constitute a part or the entirety of the porous structure. As such, these materials facilitate an intimate contact between the electrolyte and the cathode and/or the anode. These materials are typically processed by beginning with some reactive chemical species that are monomers, low-molecular weight polymers (oligomers) and curing agents. These species are activated (catalyzed or initiated) to undergo polymerization and/or chain cross-linking under the influence of heat or radiation (ultra-violet light, electron beam, ion beam, etc.). During this polymerization or cross-linking process, some of the chains can react with or be bonded to both the cathode and the anode to ensure the mechanical integrity of the invented electrochemical cell. Some of the reactive species may be water-soluble to begin with, but will become insoluble once cross-linking occurs to a critical extent. These materials may also be made in a fine powder form and added to the electrolyte phase to serve as a moisture retainer. In this role, these water-insoluble materials are preferred over water-soluble polymers because the latter tend to result in layer separation and substrate warping.

A semi-IPN begins with a mixture of a long-chain polymer and a monomer or oligomer. Once initiated, the monomer or oligomer will undergo polymerization and cross-linking to form a three-dimensional network without chemically reacting with the companion polymer. This companion polymer in the mixture becomes physically entangled with the 3-D network, forming a relatively homogeneous material. An IPN begins with two reactive oligomers or monomers which form two independent 3-D networks on a separate basis; but, the two networks of chains interpenetrate each other in such a fashion that they become physically inseparable. The formation of an IPN or semi-IPN may be allowed to occur with an attendant foaming procedure for creating the desired pores or bubbles in the desired porous structure. Foaming is well-known in the art.

A hydrogel is a lightly cross-linked polymer that is compatible with water. It also begins with some reactive or “curable” chemical species. Upon completion of curing, the hydrogel becomes insoluble in water, but can be swollen by water molecules to a controlled extent. Hence, a hydrogel is also a good deliquescent material or a moisture retainer. The hydrogel is a class of materials that is preferred over a water-soluble polymer for use as a deliquescent material. One major reason is the fact that there is practically no constraint on the amount of water that can be absorbed into the electrolyte layer by a given amount of a water-soluble polymer. This is due to the notion that the higher the water content the more dilute the polymer-water solution would be (which is more thermodynamically favorable). In contrast, a lightly cross-linked hydrogel can only be swollen by water to a limited (but controllable) extent that depends upon the degree of cross-linking. Specifically, this extent is dictated by the condition under which the chain segments between cross-links are fully stretched. This implies that, under a highly humid condition, an open electrochemical cell of the present invention can still operate very well; but, by contrast, a prior-art open cell containing a water-soluble polymer could become overly expanded and consequently lose its mechanical integrity. Hydrogels are commonly used in health care products such as for controlled release of medicine and as a super-absorbent in a baby diaper or feminine product. They are readily available at very low costs.

As an example, a process to fabricate the open electrochemical cell may begin with forming a cathode layer 16 (e.g., onto a surface 23 of a flexible substrate 20), which is followed by coating and partially curing a thin layer of an electrolyte mixture (containing a curable species, a foaming agent, an ion conductive material, and a deliquescent material) onto a major surface of the cathode layer. An anode layer is then applied onto the electrolyte layer, which is followed by fully curing and foaming the electrolyte layer. Alternatively, the electrolyte layer may be formed first by creating a thin layer of a porous hydrogel, IPN, semi-IPN, or other type of lightly cross-linked polymer that is water-compatible. The resulting porous structure is then impregnated with a mixture of an ion conductive material, a deliquescent material and some water. The electrolyte layer is then bonded to the anode and the cathode through the use of a thin adhesive layer (e.g., containing a reactive oligomer or monomer that is preferably of similar composition to the precursor to the porous structure to ensure chemical compatibility). A pressure of low magnitude may be applied to consolidate the three constituent layers together when the adhesive is being cured using a hot press.

The deliquescent material is preferably a strongly hydroscopic agent. The hygroscopic agents are preferably those which will form a pasty mix by absorbing atmospheric water vapor. A variety of metal halides such as aluminum chloride, magnesium chloride, calcium chloride, zinc chloride, or iron chloride are very useful as the hygroscopic material. In addition, metal nitrates, such as zinc nitrate, magnesium nitrate, and iron nitrate, can also be used as the hygroscopic agent. There are several organic ions which form deliquescent salts which are also sufficiently hygroscopic to serve in this invention. These include sodium formate, sodium ethyl sulfate and magnesium acetate. The deliquescent material by being hygroscopic absorbs moisture from open air to help maintain the cell moisturized at all times. We have also found that hydrogels are both good deliquescent materials and good moisture retainers. The level of moisture within the open cell may vary depending on the type and concentration of the deliquescent material selected and the air humidity level.

There is no theoretical restriction on the selection of an ion conductive material. The ion conductive material is selected in accordance with the anode and cathode materials selected. Some useful ion conductive materials are, for instance, zinc-chloride, zinc-bromide and zinc-fluoride (if the anode active material is zinc) for various primary cells and potassium-hydroxide and sulfuric-acid for rechargeable cells. Some materials may serve as both a deliquescent material and ion conductive material, e.g., zinc-chloride and zinc-bromide.

There is no limitation on the kind of anode material that can be used in the presently invented open electrochemical cell. Due to the normally high reactivity between pure lithium and water, pure lithium is not a recommended active anode material without using a host material such as a layered carbon structure. However, lithium can be an element in an alloy or mixture. Hence, the anode preferably comprises an anode active material selected from the group consisting of magnesium, aluminum, titanium, manganese, zinc, chromium, iron, nickel, tin, and combinations thereof. The anode active material may be in the form of a fine powder, a thin fiber, a thin film, a fabric, a non-woven layer, or a combination thereof. The anode or cathode may comprise a carbon powder, graphite platelet, and/or graphite fiber as additional ingredients. This is especially true of the cases where an active material such as a metal ion is transported between the anode and the cathode during the charge and discharge processes of a “rocking-chair” type metal-ion battery. The cathode preferably includes an inert material not soluble in or reactive with the electrolyte. The inert material may be selected from a group consisting of a metal oxide, sulfide, phosphide, arsenide, selenide, telluride, and combinations thereof.

Suitable pairs of materials to be used in the anode and cathode include, but are not limited to, zinc/manganese-dioxide, zinc/silver-oxide, cadmium/nickel-oxide; and iron/nickel-oxide. The manganese-dioxide and the silver-oxide may be optionally mixed with a conductive carbon powder. The three layers 12, 14 and 16 (FIG. 1) are preferably made to be thin and flexible so that the whole cell 10 is flexible. Each is preferably 0.2 mm (200 μm) or less and, further preferably, 0.1 mm (100 μm) or less, and most preferably 5 μm or less. These layers may be manufactured by a suitable printing or deposition technology, including but are not limited to, screen printing, inkjet printing, spraying, lamination, chemical vapor deposition, physical vapor deposition, and sputtering. Vapor deposition and sputtering techniques are capable of depositing layers that are thinner than 5 μm or even in the sub-micron or nanometer range.

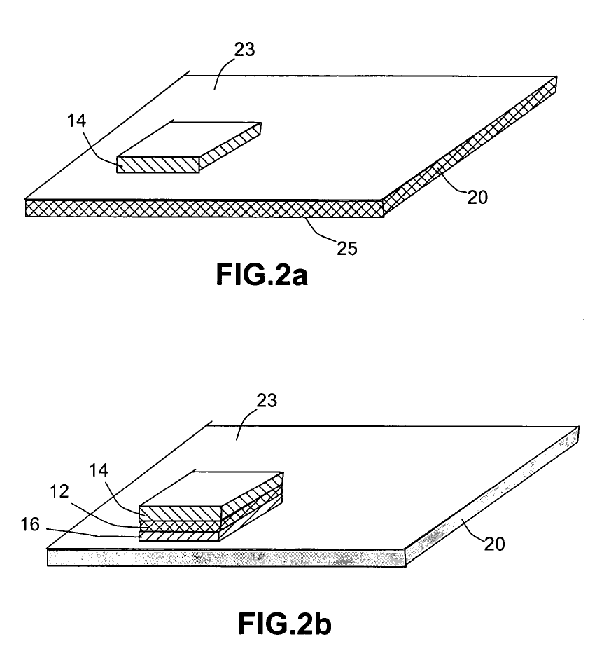

FIG. 2(a) shows a perspective view of another possible configuration of a flexible thin-layer open electrochemical cell which contains an anode 14 on the top surface 23 of a filter paper 20 and a cathode (not seen) at a corresponding location on the bottom surface 25 of the paper. The electrolyte ingredients are engaged by or impregnated in the portion of the filter paper between the two electrodes. The electrolyte-carrying portion is slightly larger that either or both of the anode and cathode layers so that the electrolyte is exposed to the open air. FIG. 2(b) shows a perspective view of another possible configuration of a flexible thin-layer open electrochemical cell with all constituent layers implemented on the top surface 23 of a flexible substrate 20.

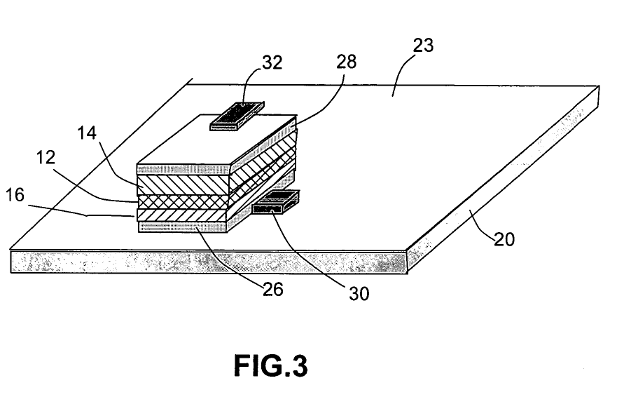

FIG. 3 shows a perspective view of a basic configuration of a flexible thin-layer open electrochemical cell comprising current collectors 26,28 and electrode terminals 30,32, in addition to the anode, electrolyte, and cathode layers. The current collectors help to pick up the electrons that constitute the current going through the external load. Suitable current collector layers are conductor materials such as graphite paper, carbon cloth and metal foil. The terminals provide locations where an electrochemical cell may be connected to other cells in parallel or in series, or other devices that need power. Terminals 30 and 32 may be located in any desired location of the current collectors (if present) or the anode and cathode (if current collector layers are missing). They may be of any suitable shape and size and, depending on the specific application, they may protrude from the surface of current collectors.

There may be a plurality of open electrochemical cells implemented on the same surface 23 or 25 (or both surfaces 23,25) of the substrate 20, although FIG. 2(a) and 2 (b) only show one such cell. Individual cells may be distributed on a surface or be arranged in juxtaposition with one another. They may be electrically connected in series to provide a desired voltage, or in parallel to provide a desired current, or both. Such a group of cells constitutes a battery.

The flexible thin-layer open electrochemical cell of the present invention has other additional features that are highly desirable. First, the cell does not need to have an external rigid casing and, hence, it is thin, light-weight, and flexible. The cells may be mass-produced by roll-to-roll techniques that involve screen printing, patterned spraying, inkjet printing, masked sputtering, etc. They may be manufactured in any size, shape, color and applied patterns and, hence, are suitable for a wide variety of applications. Second, by using a mass production technology, the manufacturing costs are reduced. Very inexpensive cells printed on a low-cost flexible substrate such as paper or plastic may be disposed of after use. Large sheets of substrate can be used with a large number of cells deposited onto the substrate at a time and then cut to any desired sizes. The substrate may be fed from a roll and, upon deposition of various battery layers, taken up by a winding roller (hence, the name “roll-to-roll” process). Third, the cell can be made of environmentally benign materials.

These additional features make it highly desirable to combine an open electrochemical cell or battery of the present invention with a functional device all on the same flexible substrate. Hence, still another embodiment of the present invention is a functional device on a flexible substrate with the device comprising a thin-layer open liquid-state electrochemical cell or a multiple-cell battery for providing the device with electrical power. The electrochemical cell or battery having the aforementioned features (having an open cell configuration with the electrolyte containing a deliquescent material and an ion conductive material) is also implemented on the same substrate. Specifically, the device includes a substrate and at least one electronic component attached to the substrate. The substrate may be selected from the group consisting of a greeting card, a business card, a radio frequency identification tag, a package of a food product, and a printed matter. The electronic component may be selected from the group consisting of an audio device, a visual device, a power switch, a light-emitting diode, a timer, a voltage regulator, an amplifier, an antenna, a transceiver, a sensor, an actuator, an integrated circuit, a memory, an electrically active ink, an electrically non-active ink and combinations thereof. These components can be painted, coated, printed, sprayed, or deposited onto the same substrate along with an open electrochemical cell or battery. Methods of printing electronic components are well known in the art. Examples include U.S. Pat. Nos. 4,353,954 (Yamaoka, et al., Oct. 12, 1982), U.S. Pat. No. 4,562,119 (Darms, et al. Dec. 31, 1985), and U.S. Pat. No. 6,639,578 (Comiskey, et al., Oct. 28, 2003). The operation of most of these electronic components relies on a power source. The present invention provides a low-cost, flexible open cell to meet this requirement.

### EXAMPLE 1

A solution containing 1800 mg of zinc-chloride (a deliquescent material and an ion conductive material) in 1.2 ml of water was prepared. A 4.5 cm×7 cm strip of a filter paper was thoroughly wetted with this solution by dipping. A mixture of 300 mg zinc powder with the above solution was prepared and was printed on one side of the paper strip serving as the anode layer. On the other side was printed a mixture of 250 mg manganese-dioxide and 50 mg of a conductive carbon powder, together with the above solution, serving as the cathode layer. When electrical contacts were made with both sides and were connected over a load an electrical current was measured. A current of 12 micro-ampers per cm² at an initial voltage of 1.7 volts was obtained. The voltage drops to a steady state of 1.4 volts for 11 days in a laboratory air (at room temperature with the humidity level being fluctuated between 25% and 75%).

### COMPARATIVE EXAMPLE 1

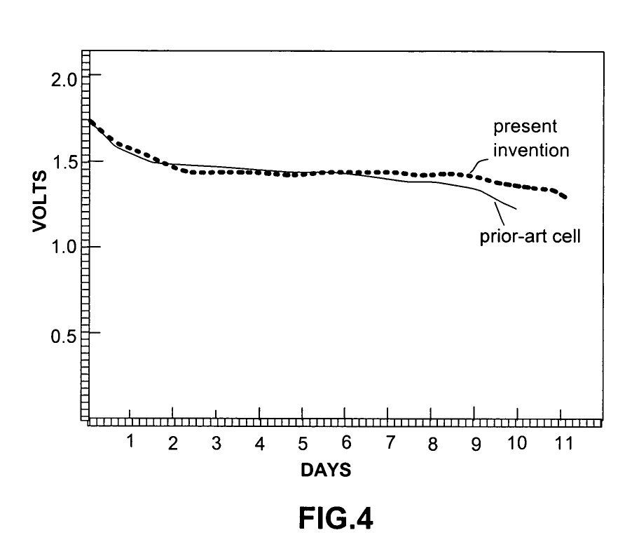

An open cell was prepared as described in Example 1, but containing an additional 120 mg of poly(vinyl alcohol) (PVA, a water-soluble polymer) in the zinc-chloride/water solution. This cell is referred to as the prior-art cell in FIG. 4. The two curves in FIG. 4 show that the open cell without the water-soluble polymer (Example 1) performs at least equally well as the prior-art open cell containing PVA. We have further found that, provided the constituent layers are properly pressed together, a water-soluble polymer is not needed to maintain good cell integrity. In fact, an excessive amount of a water-soluble polymer tends to result in partial layer separation, a phenomenon referred to as “delamination,” possibly due to a more severe hygro-thermal stresses induced during temperature and humidity fluctuations (hygro-thermal cycling).

### EXAMPLE 2

Methyl methacrylate (2.00 g, 0.020 mole) was added to N,N-dimethylacrylamide (37.67 g, 0.38 mole). This resulted in a reaction mixture having 0.05 weight fraction methyl methacrylate and 0.95 weight fraction N,N-dimethylacrylamide. The cross-linking agent ethylene glycol dimethacrylate (0.05% by weight based on total reaction mass) was then added. The reaction mixture was poured into a polypropylene sheet mold with an aluminum foil linen, with which the reaction mixture was in direct contact. The mold was then sealed off from the atmosphere and subsequently exposed to 1 MRad gamma radiation. The cured hydrogel was peeled from the foil and then “washed” in a balanced salt solution. The resulting hydrogel is highly water compatible, but not water soluble. In this case, water molecules penetrate into the interstices between cross-linked chains, but do not dissolve to separate the chains. The gel was dried and then ground into a fine powder.

A small amount of the dry gel powder was then added to a saturated potassium-hydroxide solution. A porous structure (e.g., a filter paper) is thoroughly wetted with this solution and a mixture of the solution with nickel-oxide powder is pasted on one side of the porous structure to form a cathode and, a similar mixture with cadmium powder is pasted on the other side of the porous structure to form an anode layer. By connecting a voltmeter to the two sides we observed a voltage of 1.2 volts. A high current was measured when the two layers are contacted over a load. The cell did not dry out in the open air and is rechargeable. It appears that the hydrogel is capable of absorbing and retaining the moisture and, hence, can be used as a deliquescent material.

### COMPARATIVE EXAMPLE 2

An open cell was fabricated as in Example 2, but the electrolyte contained an equal amount (by weight) of water-soluble polymer (PVA) instead of a hydrogel. The output voltage was found to be also approximately 1.2 volts, but the voltage dropped significantly after the cell was subjected to operate in a 90% humidity environment for several hours. Upon re-drying, the cell was not able to recover to its original performance level. Additionally, the substrate (paper) became warped.

### EXAMPLE 3

The same potassium-hydroxide solution as in Example 2 was prepared and a porous structure was wetted with this solution. A mixture of the solution with zinc powder was pasted on one side of the porous structure to form an anode layer and a similar mixture with manganese-dioxide powder was pasted on the other side of the porous structure to form a cathode layer. An output voltage of 1.5 volts was measured. An appreciable current value was measured when the two layers were contacted over a load. This cell did not dry out in the open air.

### EXAMPLE 4

Chitosan was obtained from Tien-Qin Bio-Materials Co. (Shanghai, China). This material was soluble in a weak acetic acid, but not in water. Chitosan in a flake form (presumably from chemically treated shrimp shells) was ground into a fine powder form and was intended for use as a moisture retainer. An open cell as in Example 3 was prepared with two modifications: (1) a small amount of chitosan was added to the electrolyte solution and (2) manganese-dioxide powder was replaced with silver-oxide. The output voltage was found to be also approximately 1.2 volts.

### COMPARATIVE EXAMPLE 4

An open cell was fabricated as in Example 4, but the electrolyte contained an equal amount (by weight) of water-soluble polymer (PVA) instead of chitosan. The output voltage was found to be also approximately 1.2 volts, but the voltage dropped significantly after the cell was allowed to operate in a 90% humidity environment for several hours. Upon re-drying, the cell was not able to recover to its original performance level. Additionally, the substrate (paper) became warped. Chitosan appears to be a good moisture retainer that does not absorb an excessive amount of water.

### EXAMPLE 5

To illustrate the efficacy of water compatible semi-IPNs as a water retainer, chitosan-PEO semi-IPN hydrogels were made as follows. Poly(ethylene oxide) (PEO) was acquired from Union Carbide, (Danbury, Conn.). Glyoxal was purchased from Aldrich Chemical Company Inc., (Milwaukee, Wis.). Chitosan and PEO were dissolved in 0.1 M acetic acid to obtain 2% (w/v) solutions of each. The cross-linking agent glyoxal, was also dissolved in 0.1 M acetic acid. The concentration of the cross-linking agent in the final semi-LPN hydrogel was 8.0 mg/ml. The hydrogels were synthesized as semi-IPN using the simultaneous method: the two polymer solutions were mixed to form a 40 ml homogenous blend. The cross-linking agent was dissolved in 0.1 M acetic acid to give a volume of 10 ml. This solution was then added to the polymer blend and mixed thoroughly, to obtain a final volume of 50 ml for the hydrogel. The blend was then poured into a petri dish and allowed to gel at room temperature. After the hydrogels were formed they were cut into discs of approximately 20 mm diameter. The discs were neutralized in 0.1 M NaOH, followed by extensive washing with deionized distilled water. These hydrogels were then dried and ground into a powder form.

An open cell was prepared as described in Comparative Example 1, but containing 120 mg of chitosan-PEO semi-IPN (insoluble in water) instead of PVA (a water-soluble polymer) in the zinc-chloride/water solution. The performance of this open cell was comparable to that of Example 1, but without suffering the layer delamination problem that occurred to the sample (containing a water-soluble polymer) in Comparative Example 1.

1. An open liquid-state electrochemical cell comprising an anode, a cathode, and an electrolyte being disposed between said anode and said cathode; said electrolyte containing no water-soluble polymer and comprising:
(a) a deliquescent material for keeping the open cell wet at all times; and
(b) an ion conductive material for helping to transport ions between said anode and said cathode;
wherein said electrolyte is exposed to open air.

2. The cell as in claim 1, wherein said electrolyte is carried by or impregnated in a porous structure.

3. The cell as in claim 2, wherein said porous structure is selected from the group consisting of a ceramic membrane, a polymer membrane, a non-woven fabric, a woven fabric, and a sheet of porous paper.

4. The cell as in claim 1, wherein said electrolyte comprises a water-insoluble but water-compatible or hydrophillic polymer selected from the group consisting of a lightly cross-liked polymer, a hydrogel, an interpenetrating network, a semi-interpenetrating network, and combinations thereof.

5. The cell as in claim 1, wherein said anode comprises an anode active material selected from the group consisting of magnesium, aluminum, titanium, manganese, zinc, chromium, iron, nickel, tin, and combinations thereof.

6. The cell as in claim 5, wherein said anode active material is in the form of a fine powder, a thin fiber, a thin film, or a combination thereof.

7. The cell as in claim 1, wherein said anode or said cathode comprises carbon powder, graphite platelet, and/or graphite fiber.

8. The cell as in claim 1, wherein said cathode comprises an inert material not soluble in or reactive with said electrolyte; said inert material being selected from a group consisting of a metal oxide, sulfide, phosphide, arsenide, selenide, telluride, and combinations thereof.

9. The cell of claim 1, wherein the ion conductive material is selected from the group consisting of zinc-chloride, zinc-bromide, zinc-fluoride, potassium-hydroxide, and combinations thereof.

10. The cell of claim 1, wherein the deliquescent material is selected from the group consisting of zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, hydrogels, and combinations thereof.

11. The cell as in claim 1, further comprising an anode current collector in physical contact with said anode and/or a cathode current collector in physical contact with said cathode.

12. The cell as in claim 1, further comprising two terminals in physical contact with said anode and said cathode, respectively.

13. A battery comprising a plurality of electrochemical cells with at least one of said electrochemical cells comprising an open liquid-state cell as defined in claim 1.

14. The cell as in claim 1, wherein said anode, cathode and electrolyte are thin layers so that the cell is flexible.

15. The cell as in claim 3, wherein said porous structure is a thin layer having two opposite surfaces with a first surface in physical contact with said anode and a second surface in physical contact with said cathode.

16. The cell as in claim 15, wherein both anode and cathode are thin layers with a thickness smaller than 20 μm so that the cell is flexible.

17. A functional device comprising a flexible thin-layer open liquid-state electrochemical cell as defined in claim 14 for providing said device with electrical power for its operation.

18. A functional device comprising a flexible thin-layer open liquid-state electrochemical cell as defined in claim 15 for providing said device with electrical power for its operation.

19. The device of claim 17, wherein said device includes a substrate and at least one electronic component attached to said substrate, said at least one electronic component is for performing a sensible function.

20. The device of claim 19, wherein said substrate is selected from the group consisting of a greeting card, a business card, a radio frequency identification tag, a package of a food product, and a printed matter.

21. The device of claim 17, wherein said electronic component is selected from the group consisting of an audio device, a visual device, a power switch, a light-emitting diode, a timer, a voltage regulator, an amplifier, an antenna, a transceiver, a sensor, an actuator, an integrated circuit, a memory, an electrically active ink, an electrically non-active ink, and combinations thereof.

22. The device of claim 18, wherein said device includes a substrate and at least one electronic component attached to said substrate, said at least one electronic component is for performing a sensible function.

23. The device of claim 22, wherein said substrate is selected from the group consisting of a greeting card, a business card, a radio frequency identification tag, a package of a food product, and a printed matter.

24. The device of claim 18, wherein said electronic component is selected from the group consisting of an audio device, a visual device, a power switch, a light-emitting diode, a timer, a voltage regulator, an amplifier, an antenna, a transceiver, a sensor, an actuator, an integrated circuit, a memory, an electrically active ink, an electrically non-active ink, and combinations thereof.
